(19) United States
(12) Patent Application Publication
(10) Pub. No.: US 2016/0063521 A1
(43) Pub. Date: Mar. 3, 2016

(54) CHANNEL PARTNER ANALYTICS

(71) Applicant: Accenture Global Services Limited, Dublin (IE)

(72) Inventors: Bruce T. Brown, Herndon, VA (US); Jai Advani, Dublin (IE); Paul J. Neumann, Dublin (IE)

(21) Appl. No.: 14/473,876

(22) Filed: Aug. 29, 2014

(51) Int. Cl. G06Q 30/02; G06Q 10/06

(52) U.S. Cl. CPC G06Q 30/0202; G06Q 10/067

(57) ABSTRACT

Described is a technology by which channel partner analytic records (CPAR) are arranged and processed to obtain value from the data provided by channel partners. Included is collecting and joining disparate channel partner data into a combined dataset, generating insights from the combined data set, and taking action based upon the insights. To this end, the technology comprises a channel partner data model, a set of metrics and performance indications, and sets of analyses with respect to a given industry.

### BACKGROUND

A channel partner generally refers to an enterprise that markets, sells or otherwise distributes products and/or services supplied by another company. Channel partners operate as part of a network or chain of intermediaries to distribute the products and/or services.

A significant amount of data may be collected regarding such channel partners and the interactions with them. At present, such data is maintained in disparate data sources, but there is no structured way to utilize the various aspects of this data. As a result, businesses that attempt to use this disparate data expend significant resources, which is inefficient, and may also miss opportunities to increase revenue.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology (e.g., implemented as a framework) by which an integrator component integrates channel partner data from data sources into channel partner database records of an integrated channel partner database. Historical (including exploratory) analysis logic is configured to build a model corresponding to the one or more channel partners from a database view, in which the database view corresponds to one or more channel partners and is generated from the integrated channel partner database records across multiple dimensions of a single record set. Predictive analysis logic uses the model, including to input attributes of another channel partner or potential channel partner into the model to receive output corresponding to the other channel partner or the potential channel partner. The predictive analysis logic is further configured to use the output to determine a prediction score.

Other advantages may become apparent from the following detailed description when taken in conjunction with the drawings.

### BRIEF DESCRIPTION OF THE DRAWINGS

The present technology is illustrated by way of example and not limited in the accompanying figures in which like reference numerals indicate similar elements and in which:

FIG. 1 is a block diagram showing example data sources and components that are used for providing an integrated database of channel partner records, according to one or more example implementations.

FIG. 2 is a block diagram showing components comprising hardware and/or software in hardware configured to process tables into an integrated database of channel partner records, according to one or more example implementations.

FIG. 3 is a flow diagram showing example logic that may be used to integrate and maintain an integrated database of channel partner records, according to one or more example implementations.

FIG. 4 is an example representation of example data (e.g., in fields) that may be maintained and accessed in a channel partner record, according to one or more example implementations.

FIG. 5 is an example representation of how hierarchical relationships between distributor and reseller channel partners may be related in channel partner records, according to one or more example implementations.

FIG. 6 is an example representation of analytical information that may be processed from channel partner records, according to one or more example implementations.

FIG. 7 is a flow diagram showing example logic that may be used to leverage channel partner records for analytics, according to one or more example implementations.

FIG. 8 is a flow diagram showing example logic that may be used for insight generation based upon data from an integrated channel partner database, according to one or more example implementations.

FIG. 9 is a block diagram showing example logic implemented in memory that may be used for insight generation based upon data from an integrated channel partner database, according to one or more example implementations.

FIG. 10 shows an illustrative example of a computing environment into which various aspects of the present technology may be incorporated.

### DETAILED DESCRIPTION

Various aspects of the technology described herein, (e.g., implemented as a framework), are generally directed towards channel partner analytics, including a channel partner analytics record (CPAR) related to channel partners. In one or more example implementations, a CPAR includes a database object that is associated with a system and/or process to act on the database object. The CPAR database object may comprise a database record that is analyzed or otherwise processed for analytics or other purposes.

In one or more example implementations, a channel partner analytics technology framework is directed towards collecting and joining channel partner data into a structured (e.g., combined) dataset, which is then used to generate insights by analyzing records from the structured dataset. An example of an insight is a reasoned calculation as to whether or not to invest more resources in a particular channel partner. Once structured, the data and associated analytics provide benefits that include a more thorough understanding of the channel partner network, identification of partner performance levels and allow for historical analysis across multiple dimensions not feasible otherwise by looking at different databases, including predictive modeling, for example. For example, analysis across multiple dimensions from the structured dataset may include obtaining a set of one or more database records from a single query, whereas different queries on different databases are needed, followed by manually assembling the query results from the disparate databases.

By way of example, and not limitation, a CPAR framework may include a channel partner data model, a matching process, one or more sets of metrics and performance indicators, and one or more sets of predetermined analyses with general impact for a given industry. The CPAR is applicable for any company that employs or otherwise works with channel partners, such as a consulting services business that assist clients in increasing profits and reputation. A CPAR may be optimized as needed by integrating relevant data, such as data closely related to high technology industries.

As one example, CPAR technology assists in providing, marking and selling channel partner consulting work, while also accelerating project delivery and reducing delivery risk for the partner. For example, CPAR processes may comprise a preconfigured methodology for linking disparate data sources to create a more complete view of channel partners and interactions with them. Note that as used herein, a “view” may refer to any human readable and/or machine-readable output obtained by accessing the integrated database, typically obtained by an actual or virtual query.

A CPAR database object may comprise a database record that is analyzed or otherwise processed for analytics or other purposes. In general, data is collected from the channel partners and/or other data sources. Analytics are performed on the data, and the analysis results used to obtain insights that help in making decisions, such as further investments in a channel partner, for example. The data may be collected through various sources, such as independent data sources, internal data sources, external data sources, and/or other suitable data sources, including public or private (e.g., purchased) data sources. The data store used for storing the integrated data may comprise any known data storage mechanism or combination thereof, such as a relational database.

It should be understood that any examples, data structures, analysis techniques and so forth described herein are non-limiting examples. For one, the technology described herein may be applied to a single enterprise that has disparate data as well as channel partners. As such, the present technology is not limited to any particular example implementations, aspects, concepts, structures, functionalities or examples described herein. Rather, any of the example implementations, aspects, concepts, structures, functionalities or examples described herein are non-limiting, and the present technology may be used in various ways that provide benefits and advantages in computing, data storage and analytics in general.

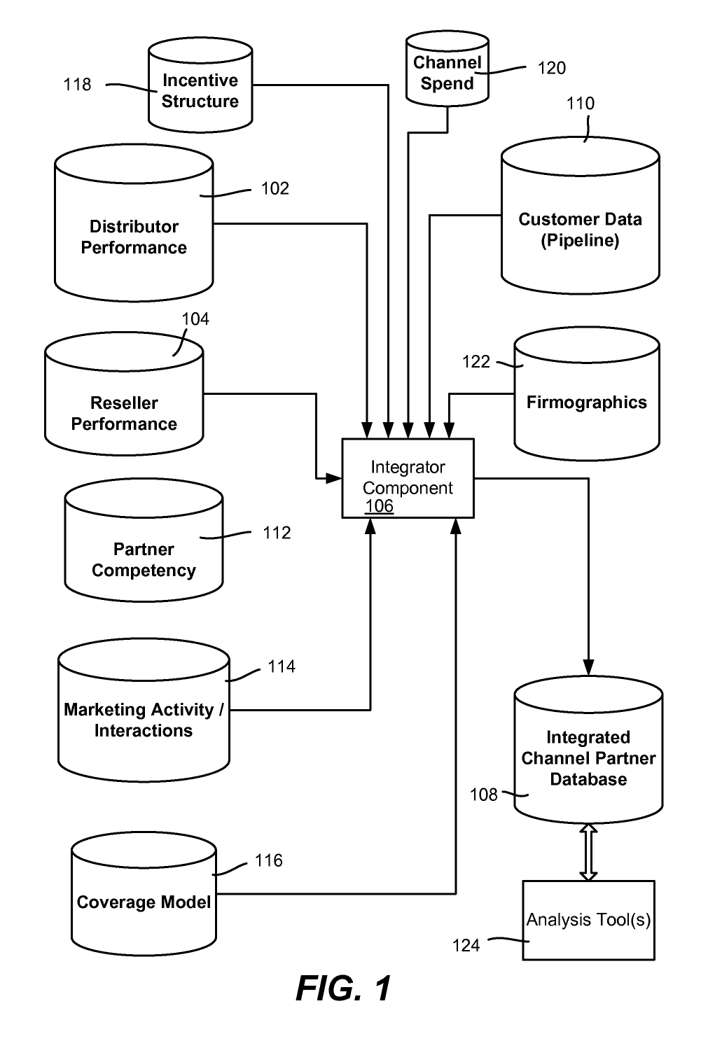

With reference to FIG. 1, a plurality of source data stores are depicted, including a distributor performance data store 102 containing information that tracks aspects such as one or more distributors' sales and revenue, inventory, orders/shipment and any other service metrics. A reseller performance data store 104 is also available, including similar attributes including sales and revenue, inventory, service metrics, as well as additional attributes related to each reseller such as orders/shipment and, fulfillment affiliation with distributor.

As will be understood, these and other data stores may be combined (e.g., via an integrator component 106) into an integrated channel partner database 108. The integrator component 106 may access the data store based upon SQL or SAS technology, for example, to merge/join data, filter data, optimize queries and so forth to obtain the data desired to fill the CPAR database fields.

One aspect of integration is directed towards generation of a Channel Partner Identifier (CP ID) that is unique among the integrated channel partner database 108. By way of example, some or all of the channel partner name, location, address/zip code, telephone number and/or other data may be used to create the unique CP ID. Unlike the disparate tables, the CP ID provides a consistent way to refer to a channel partner.

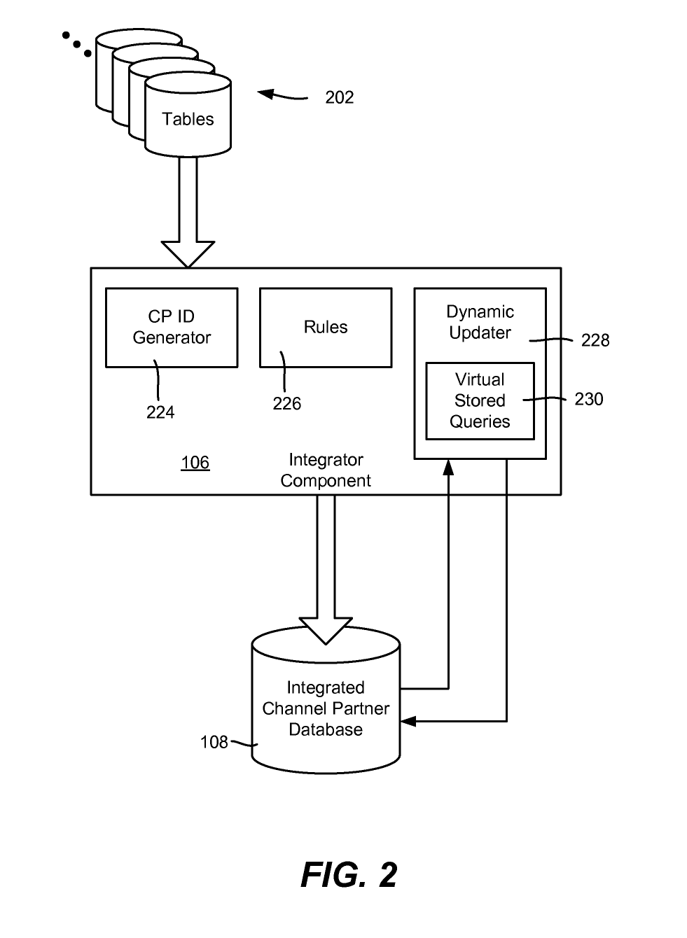

FIG. 2 shows how an integrator component 106, implemented via logic and/or software executing in hardware, may process the disparate tables (cumulatively 202) into the integrated channel partner database 108. A CP ID generator 224 extracts unique data for a channel partner from a certain data store or set of data stores, and generates the CP ID from that data. Part of all of the data may be concatenated into the CP ID used as is and for example, or further may be appended with a random number, hashed and so forth. Note that in an environment in which a suitable unique identifier system already exists, that unique identifier may be used as the CP ID.

Further, rules 226 may be applied, including to make the fields consistent with respect to naming conventions. This may include converting named fields that mean the same thing into a common name, e.g., “revenue” in one data source may be “income” in another data source, and rules 226 are set up to handle such situations. In general, the rules 226 are designed to make the terminology consistent in the integrated channel partner database 108. Note that the rules 226 may be hardcoded into the integrator component 106, or maintained separately and coupled thereto to facilitate revising of the rules 226.

Indeed, one aspect of the framework described herein is to overcome an existing situation in which data elements are stored by diverse departments in multiple tables/sources. Instead of disparate sources, the CPAR framework provides a central repository (e.g., the integrated channel partner database 108) of relevant data. Without integration, the same terminology (e.g., terms/field identifiers/names) may mean different things in different tables (e.g., in one table “income” may refer to “gross income” whereas in another table it may refer to “net income”). At the same time, what is actually meant to be the same term/field labeled with the same identifier/name may have different term or field names amongst the disparate sources, e.g., “training” in one table may be referred to as “certification level” in another.

Thus, one aspect of CPAR is directed to using consistent terms/fields and definitions across the various sources (e.g., business units) so that any inconsistent and/or contradictory data fields/terms in the various data stores (different tables) are translated to the same terms/field definitions. Mutual contradictions and/or inconsistencies in data values are resolved by such rules 226. As one example, different data elements are often maintained at different levels; e.g., channel partner, transaction, agent level and so on, whereas CPAR technology rolls up the desired data at the channel partner level into a single view. To this end, inter-linkages between various tables/data sources are made consistent with well-defined rules 226.

In another aspect, derived fields may be provided. In the CPAR framework, whenever raw data is updated, any derived fields are automatically updated, e.g., via a dynamic updater 228 that may include virtual stored queries 230. By way of example, if a derived field sums up a value in one field with that of another field, changing one field automatically changes the derived field. Unlike disparate data stores, the virtual stored queries 230 along with the integrated channel partner database 108 provide such a dynamically updateable table; (note that as used herein, “dynamically” may or may not be instantaneous or near-instantaneous, but in any event the field is automatically updated so that stale data is generally not provided). Note that derived fields need not be in the same record; as one example, changing one channel partner's market share can automatically/dynamically update the other channel partner's market share field in all other records. Note also that the dynamic updater 228 may be a separate component from the integrator component 106, as dynamic updating may occur while building the usage of the integrated channel partner database 108, and if the integrated channel partner database 108 is updatable during usage, e.g., in “what if” scenarios a user may change a value in one field that is updated in derived fields to generate different insights.

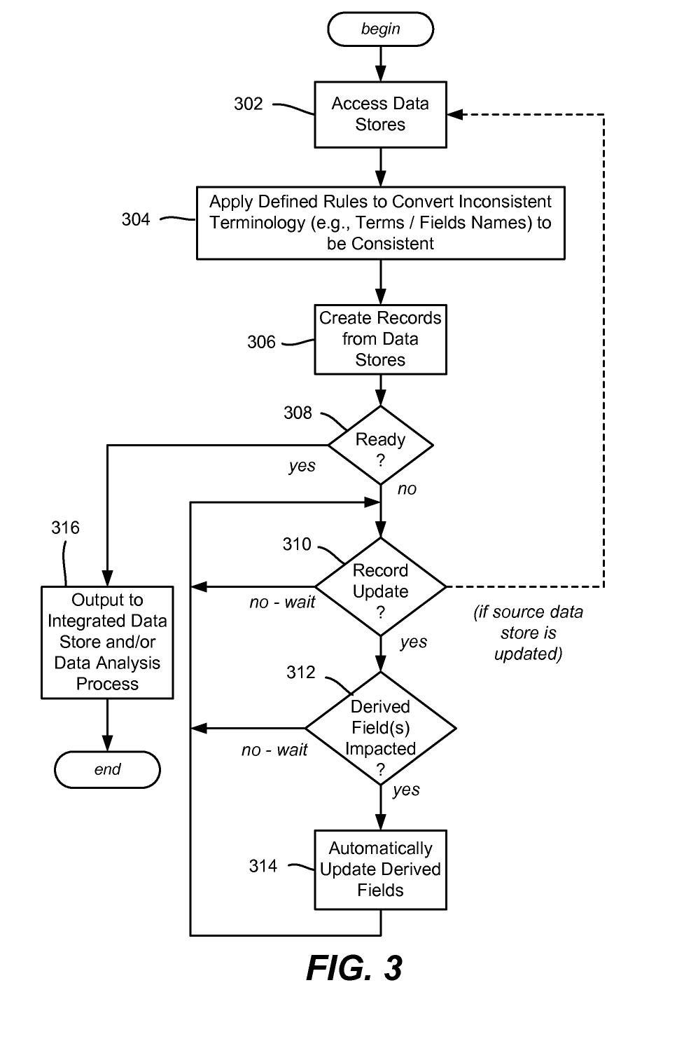

FIG. 3 provides an example of how the data stores may be accessed and used to provide a dynamically updated integrated CPAR database 108. In FIG. 3, step 302 represents accessing the various data stores, such as those exemplified in FIG. 1, to construct and later maintain the integrated database. Step 304 represents using rules or the like to convert otherwise inconsistent fields or terms to match with each other. For example, a data source may have a set of conversion rules associated therewith that apply to certain fields, and as records from that data source are accessed, the rules may be applied as part of configuring the database. Step 306 creates the records from the disparate data sources.

At this time, the data store may be ready for use, e.g., as represented via step 308 and step 316 which outputs the data store to an integrated data store and/or data analysis process 316. Note that there may be multiple instances of the integrated data store, with one instance used as needed for analytics, for example, while another instance is being built as data is updated.

When a record in the integrated database 108 is updated, steps 310, 312 and 314 represent dynamically updating any derived fields via the dynamic updater 228. This may be relatively immediate, or at least performed before any analytic queries are processed so that any data to be analyzed is relatively fresh. Further, if any source data store is updated, step 310 represents (via the dashed line) returning to step 302 to create new records and/or update existing records. Because the data stores are coupled to but not necessarily controlled by the CPAR framework, this creation/updating may be periodic or otherwise performed as needed, e.g., daily or on demand.

Returning to FIG. 1, other exemplified data stores that may be integrated include one for customer data 110, such as for data that describes attach/renewal rates, customer value, and depth and breadth of relationship. A partner competency data store 112 may be available that maintains and tracks partner skill/competency-related concepts such as certification and/or training levels.

Yet another exemplified data store in FIG. 1 is a marketing activity/interactions data store 114 that maintains and tracks marketing-related information, including concepts such as contact history, service delivery performance and other marketing-related activities. A coverage model data store 116 tracks coverage information or the like regarding channel partners; examples of coverage information include total market, overall share of “wallet” (share of revenue and/or profits), share of wallet by solution, sales territory hierarchy and so on.

Further exemplified data stores include an incentive structure data store 118 that maintains information such as contract terms, incentives, any claims, contra (money returned)/commissions, warranty payments and the like. Another exemplified data store may include a channel spend data store 120 that maintains information such as market development funding, general funding, training funding and so on. A firmogrpahics data store 122 is exemplified, and tracks data for a firm such as industry, size and revenue.

It should be understood that the above-described data stores are only some of the many possible examples of how existing data may be arranged and/or organized (and typically is in many organizations) into disparate sets of data. Data stores relevant to any business scenario may be leveraged, and need not include those described above. Further, any of these exemplified data stores may be combined into a lesser number of stores, or further separated into a greater number of stores.

The integrated channel partner database 108 may be a table that consolidates the data at a channel partner level. For example, in one or more example implementations, the table may comprise a single row per channel partner, with the attributes desired for analysis and for modeling. To capture channel partner data in as much detail as possible, each record may comprise on the order of several hundreds of fields (only some of which are exemplified herein); indeed, the fields shown herein are only examples, and channel partner data may be represented in any number of fields depending on a given example implementation and technology or other business area.

In one aspect, the technical effect of the CPAR framework described herein is to permit faster analytical solutions by consolidating data in a single view at a channel partner level. Thus, CPAR framework may be used instead of or in addition to conventional data schema/data warehousing, depending on a given scenario.

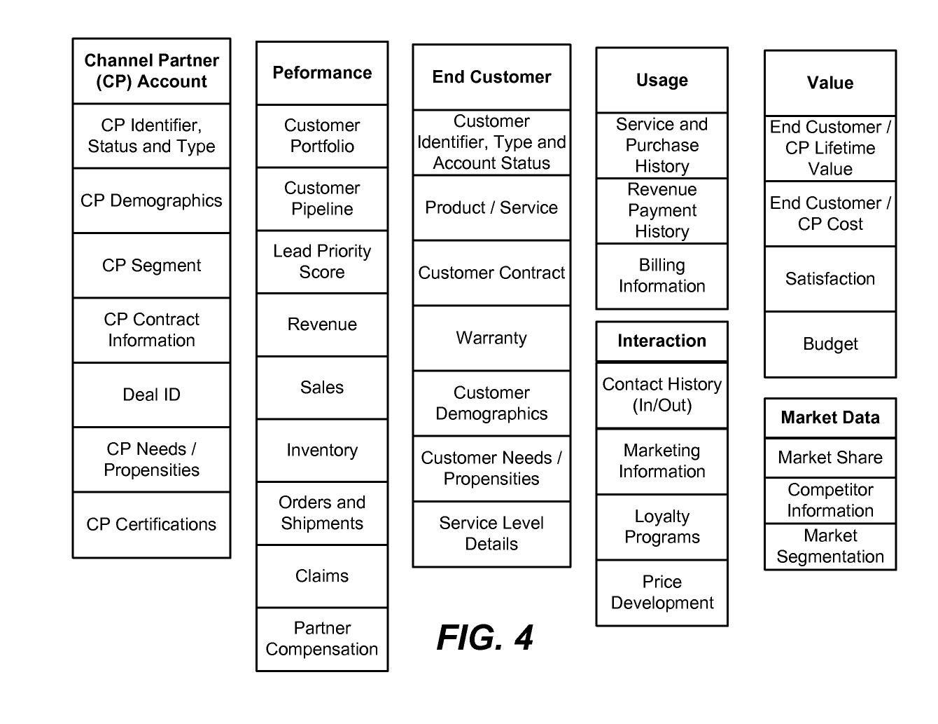

FIG. 4 shows examples of some of the data that may be maintained in the integrated data store 108. It is understood that FIG. 4 is not intended to show any actual given record or any structure of the fields, but rather exemplifies some of the data that may be maintained in association with a channel partner. Further, it is understood that any of the fields, rather than directly containing the data itself, may contain links to the data maintained within another source. However, consistency and dynamic updating is generally desirable, and thus if links to remote data are used, some processing on any remotely maintained data may be performed before forming a view of the data.

In general, FIG. 4 shows groupings of fields of information that arrange a “record” related to a channel partner identifier, along with related information, such as performance data, the end customer, usage data, interaction data, value data and market (“market intelligence”) data. Any of the fields may be keyed in a search, for example. Also, there may be different records for the same channel partner, e.g., a channel partner may have multiple end customers, whereby multiple records may be maintained instead of having different groups of fields for each end customer. As can be readily appreciated, any information that may be associated with a channel partner and is maintained in a data store may be used in the CPAR framework. This information may be customized based upon the business type, and as is understood, the fields in FIG. 4 are only examples. A field also may be left blank or marked non-applicable.

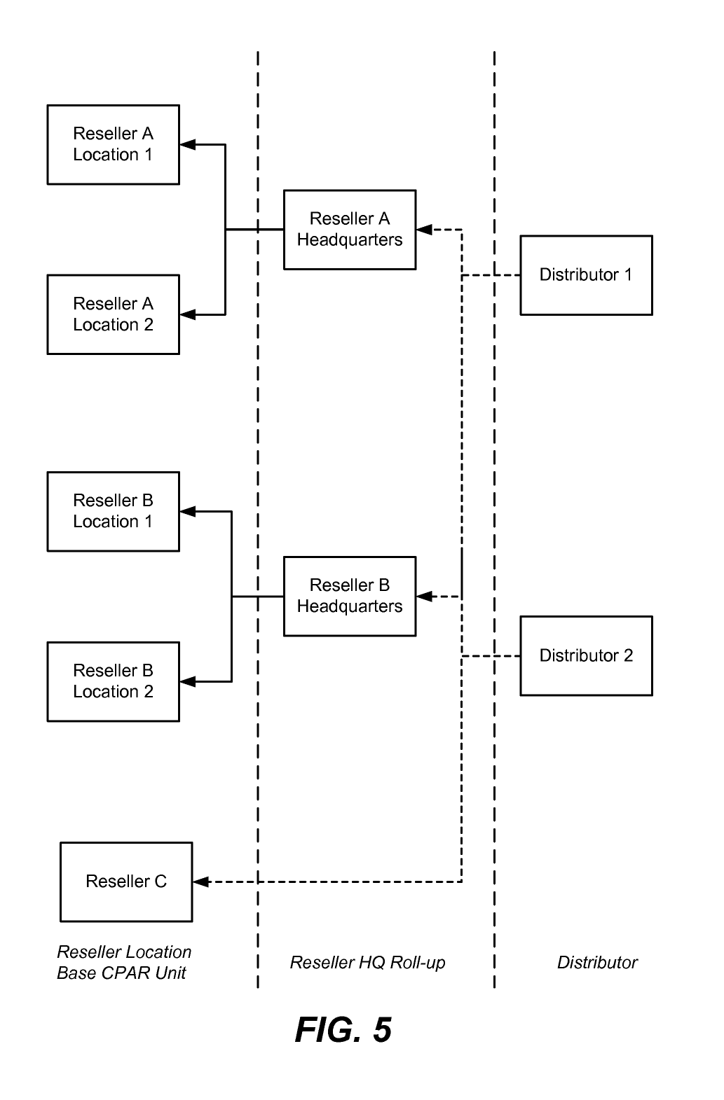

FIG. 5 shows another aspect of the framework, which is directed towards the hierarchies relating resellers and distributors in a channel partner arrangement. In FIG. 5, each reseller is associated with a location, which may be used as the base CPAR unit for distinguishing among resellers. Each distributor is associated via the records in the integrated database 108 with each reseller (e.g., the headquarters) with which the distributor conducts business, however each reseller may be further distinguished by its location. Still further, there may be additional levels (e.g., distributors to wholesalers to retail resellers) in the hierarchy. In any event, a view of the hierarchy is able to be generated from the records.

As can be appreciated, the technology described herein thus provides a preconfigured methodology for linking disparate data sources to create a more complete view of channel partners. This includes a way to establish and maintain forward (distributor to reseller) and (reseller to distributor) hierarchies. Further, any of the database data may be accessed with predesigned analytic methods and questions that drive value from a channel, such as key performance indicators.

Another example hierarchy relates to training/certification. In many instances, a person cannot be trained to a next certification level until a prior certification level has been completed, forming a hierarchy. Thus, given the numbers of channel partner employees at each certification level in fields in a flat record, a hierarchical view of the information may be generated.

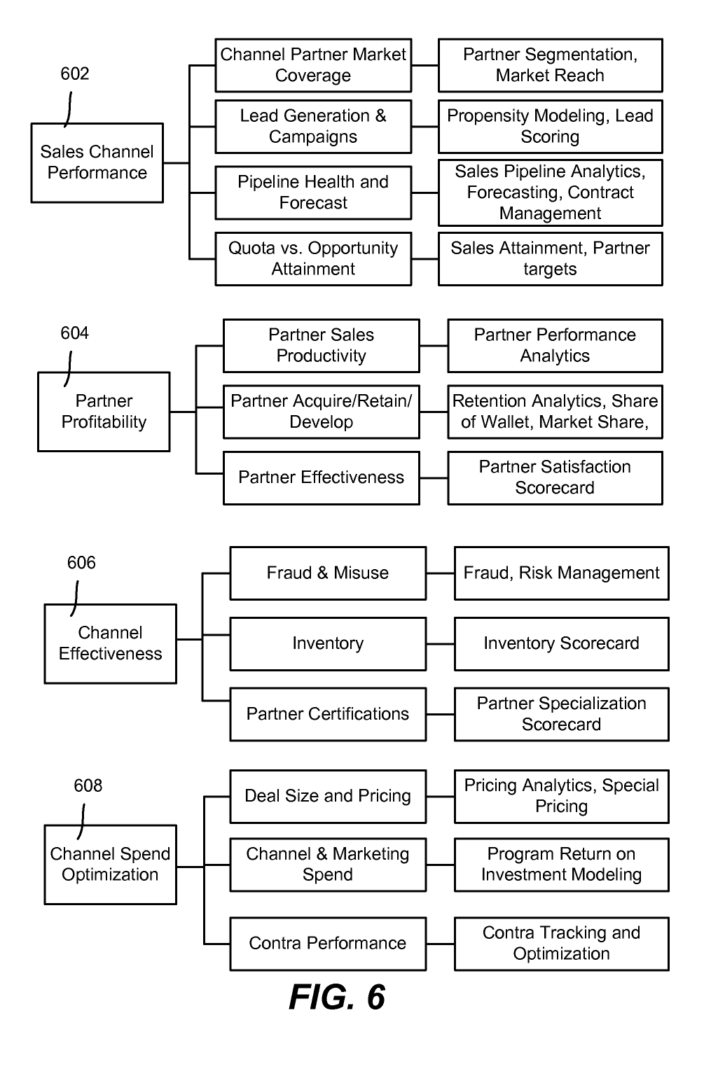

FIG. 6 shows some of the example information that may have analytics performed thereon based upon the data in the integrated data store 108 of FIG. 1. In FIG. 6, example business outcomes including sales channel performance 602, partner profitability 604, channel effectiveness 606 and channel spend optimization data 608 are shown as being able to be analyzed.

Suitable analytics tools 124 (FIG. 1) may be used to analyze the data in the integrated data store 108. For example, descriptive analytics may be used to analyze historical information. Predictive models may be defined and executed to determine which partners should be approached for a given purpose, e.g., for further investment, to increase incentives, to renew a contract (and upon what terms), and so forth. A predictive model may be trained using insight obtained from the data over time obtained via descriptive analytics relative to other known methods; such training of analytic models is well known in the art, as are the tools to accomplish the modeling.

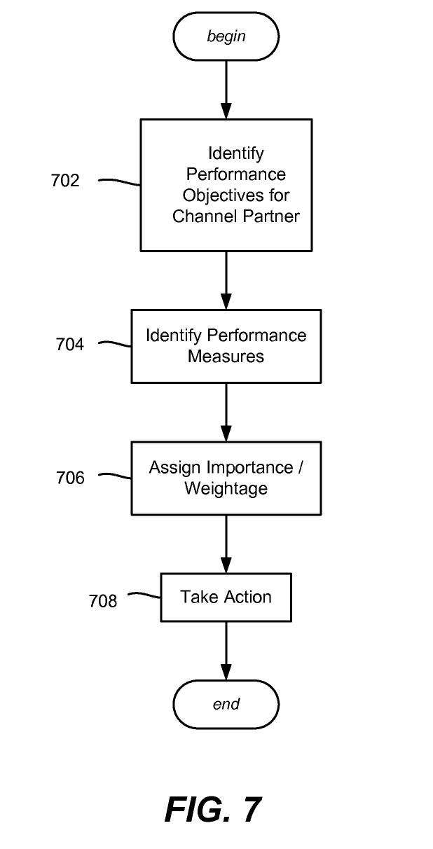

FIG. 7 shows an example of how the integrated database may be used to make a decision based upon analytical insights. In FIG. 7, step 702 represents identifying performance objectives for a channel partner, e.g., a vendor in a high technology industry). For example, this may include an analysis of how well a given channel partner contributed to a client's financial performance, how well the customer value proposition was delivered, whether the channel partner complied and performed with internal business processes, and so on. Further, over time, analytics may determine whether the channel partner sustained, changed and/or improved upon the performance.

Steps 704 represents identifying the performance measures to be used, while step 706 represents assigning an importance/weight to each performance measure. Based upon the measures, step 708 represents taking an action, such as to decide to invest more in a certain channel partner. In this way, answers to questions may be scored, based upon any of various performance measures that are identified, with different weights (e.g., learned) assigned to each answer, for example. Appropriate action may then be taken. Examples include making an investment decision, controlling another technological system such as adjusting a budget, and so forth.

Note that instead of a client, a manufacturer or the like may perform such analytics directly on a channel partner. In general, the CPAR framework can be used by any firm that leverages channel partners to market and/or distribute their product and services.

In this way, the CPAR framework helps create insights across multiple dimensions of information. For example, consider that account details (e.g., partner type (certification), tenure, loyalty indicator, key partner flags and others (contractual agreement) along with competition information (intensity of a competitor, and what are its offerings/any differentiator) are desired for analysis. Via CPAR, the desired information may be queried from the single integrated database, even though not all of the information may be in a single database before integration.

Analytics on a view from a channel partner analytic record set (one or more fields from one or more records) obtained from the integrated database thus may provide insight into the channel partner's business outcome/value to a client or product/service provider, the insight into how the channel partner interacts with the client and insight into the channel partner's potential.

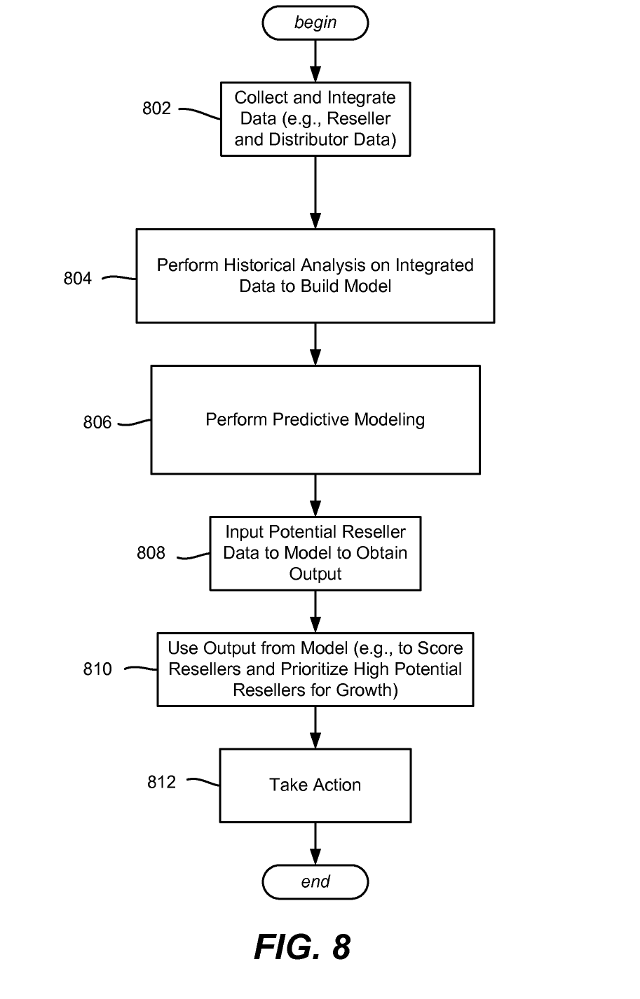

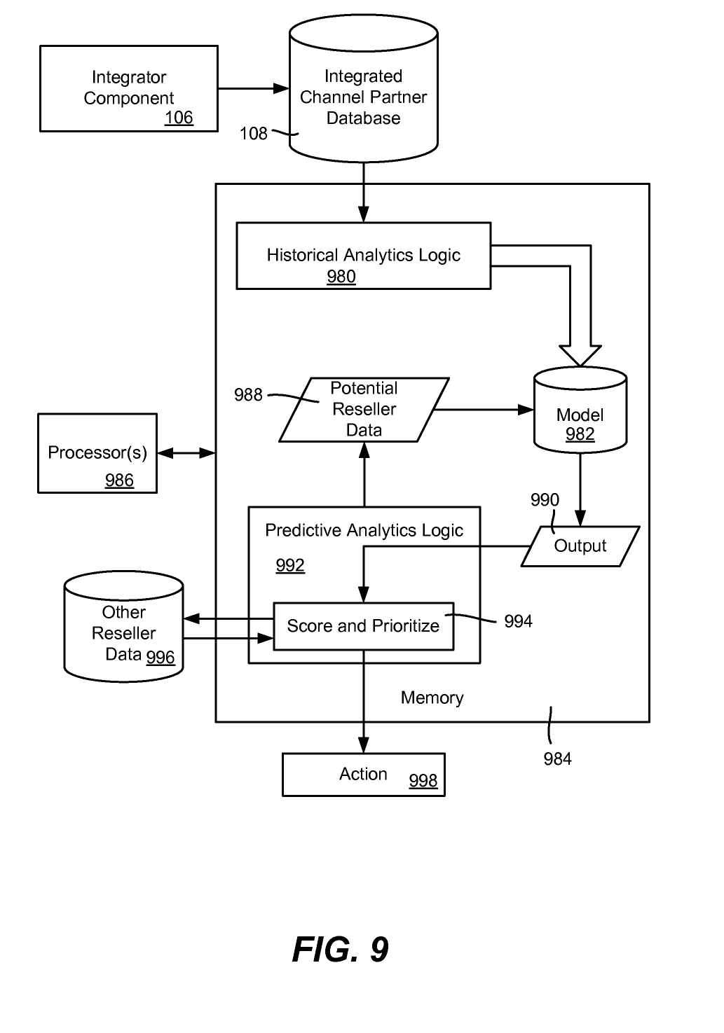

By way of a more specific example, FIGS. 8 and 9 show how an action may be decided and taken or not taken (or to what level) based upon analytics using the CPAR framework. Note that in FIGS. 8 and 9, the steps and represented logic may be executed at different times and or in separate processes, e.g., the integrated channel partner database may be built at one time and separately analyzed at a later time.

In FIGS. 8 and 9, consider an example in which an investment decision is being made with respect to a potential reseller. Step 802 represents collecting data for integrating into the CPAR database as described above. In this example, the integrated data includes at least reseller and/or distributor data for existing resellers/distributors. In FIG. 9, this is represented as the integrator component 106 generating the integrated channel partner database 108.

Step 804 (FIG. 8) uses the existing data to perform historical (including exploratory) analysis such as to build a model therefrom, e.g., via logistic regression. As shown in FIG. 9, this is represented by historical analytics logic 980 which builds the model 982. As can be readily appreciated, the historical analytics logic 980 may comprise software in a memory 984 that is executed by one or more processors 986.

The model 982 is based upon using CPAR framework to obtain insights that help to identify high performing partners and lesser performing partners, and gather attributes that correlate with partners' performances. The model 982 may be validated and used in prediction, e.g., by developing a lookalike model that may be used to determine key attributes/characteristics of high performing partners and/or those of less performant partners.

With respect to predictive modeling/analytics (step 806 of FIG. 8 and block 992 of FIG. 9), at step 808 potential reseller data 988 (FIG. 9) is input to the model to obtain predictive output 990. For example, a potential reseller or set of resellers each may or may not have some of the attributes/attribute values that are common among high performing partners, and values for the attributes of the potential partner or partners are thus input into the model to obtain the predictive output 990. Note that historical analytics may be performed separately in terms of time/memory from predictive analytics, e.g., the model 982 may be built at one time on one machine, and later used for predictive analytics on another machine. Thus, although shown in FIG. 9 as being in the same memory 984, it is understood that “memory” represents a single memory at the same time or at different times, or a combination of separate memory units at the same time or at different times, and the like. Similarly, the integrator component may be in the memory 984, but is not shown therein in FIG. 9 for purposes of clarity.

Step 810 represents using the output from the model, e.g., to score resellers and prioritize high potential resellers for growth, as also shown via block 994 in FIG. 9. For prioritizing (e.g., ranking) and any other purpose, other reseller data 996 may be accessed, e.g., the scores (actual or predicted) of other resellers may be recalled for ranking or other uses. The score or other data computed for this potential reseller also may be saved in the data 996.

Step 812 of FIG. 9 and block 998 of FIG. 9 represent taking an action, such as initiating a reseller investment decision based upon the scoring and prioritization information obtained at step 810. Note that the action may be manual or automated, at least to an extent, e.g., an automated process may compute an investment value, in which event at least some of the action block 998 of FIG. 9 may be in the memory 984 or another memory. Other automated actions may be to communicate with (e.g., trigger) another technological system, such as a budgeting system (e.g. so as to cause an adjustment of an amount of a budget allocated to a particular channel partner up or down based on the results of the scoring and prioritization information obtained at step 810), send a communication to an interested recipient (e.g., management), and so on.

In addition to account details and competition data, other examples of data that may be accessed in a single record set that was previously not accessible across the disparate data stores (including those at least similar to those described in FIG. 1) may include:

Market:
Potential
Size
Growth
Location

Firmographics:
Business type
Industry
Geography
Size (e.g., number of employees, annual revenue, growth, profitability, non-client revenue)

Product:
Product portfolio
Shifts
Trends
Product-wise plan,
Achievement
Time since last purchase

Interaction History:
Number of resources trained on client products
Last competency/training date
Number of inbound/outbound contacts by partner (email, call center, Web interactions)
Issues

Issues and Resolution History:
Partner satisfaction scores
Account
Representative Partner
Complaint history and resolution

Potential Customer:
Segment
Needs
Share of Wallet

Growth, Market Share and Profitability:
Sales
Sales growth
Trend
Profitability
Cost to serve
Annual Business Plan

Marketing:
Performance versus target
Marketing investment

CPAR technology as described herein may be used in many ways, including those not yet fully realized. Channel segmentation is one example use case scenario, in that CPAR technology can be used to develop channel segments to enable a client or other user to focus on strategic and profitable partners. Channel segments may form the basis for differential treatment of channel partners, e.g., with respect to the level of investment and overall service.

Another usage scenario is partner coverage modeling, which helps a client understand the partner coverage gap so that the client can prioritize investment decisions. Channel partner coverage modeling is a process by which companies can invest in the right partner capacity to meet channel sales targets by optimizing recruiting and/or enablement spending.

Program performance analysis is another usage scenario that helps result in the deployment of effective incentive programs, and help to maximize the overall return on investment of such incentive programs. Partner growth analysis helps determine the characteristics of high-performing (or likely to be high performing) partners and helps develop such partners further.

Compliance modeling may be used to determine non-compliant claims with minimal manual investigation. Demand forecasting/inventory analysis is a usage scenario that predicts sales at regional/sub-regional/channel partner levels. Such forecasts can help maintain the right level of inventory at various levels of a supply chain.

As can be seen, the analytic record technology described herein allows the linking of channel partners to future business outcomes. Once the data is integrated into an appropriate view, predesigned analytic methods may be used to answer questions that predict a channel partner's value, provide key performance indicators of channel partners, and maintain and provide a view of multiple distributer and reseller hierarchies hierarchy. Distributors may thus obtain improved data and actionable insights to improve reseller performance, measure the effectiveness of a distributor/reseller relationship by evaluating certification, training and other data to help improve productivity and profits.

As can be seen, described is a technology (e.g., framework) directed towards directed towards a technology (e.g., implemented as a framework) by which an integrator component in memory integrates channel partner data from data sources into channel partner database records of an integrated channel partner database. Historical analysis logic is configured to build a model corresponding to the one or more channel partners from a database view, in which the database view corresponds to one or more channel partners and is generated from the integrated channel partner database records across multiple dimensions of a single record set. Predictive analysis logic uses the model, including to input attributes of another channel partner or potential channel partner into the model to receive output corresponding to the other channel partner or the potential channel partner. The predictive analysis logic is further configured to use the output to determine a prediction score.

The predictive analysis logic may be coupled to other reseller data, to evaluate the prediction score with respect to at least one other prediction score of the other reseller data.

The memory may includes at least part of an automated action process. The automated action process may used in making a financial decision based upon the output from the model, and/or in communicating with another technological system.

The historical analysis logic and/or predictive analysis logic may comprise at least one predetermined analytic method configured to output statistical information with respect to a channel partner. The predictive analysis logic may comprise at least one predetermined analytic method configured to output statistical information with respect to a channel partner.

The integration component may combine data from a data source related to reseller performance and a data source related to distributor performance. The data sources may include an incentive-related data source, a customer data source, a firmographics data source, a marketing data source, a coverage data source and/or a spend data source.

The integration component may be coupled to or incorporate a set of rules that ensure consistency between terminology in the channel partner database fields or terms, or both, among the data sources. The integration component may be coupled to or incorporate a set of queries configured to dynamically update at least one field in at least one record when at least one other field in another record is changed in the channel partner database or in a data source.

One or more aspects are directed towards integrating channel partner data from a plurality of data sources into channel partner database records of an integrated channel partner database, including accessing each data source via an integrator implemented in memory to input data for the integrated channel partner database. Rules may be used on the input data, including detecting terminology corresponding to data in one data source and converting that terminology to other terminology to provide consistency of terminology among the channel partner database records. A database view of at least some of the channel partner data is output, and performing historical analytics and/or predictive analytics are performed based upon the database view.

A channel partner identifier may be created for at least some of the database records. The data representing the database view may include data that represents hierarchical relationships between channel partners.

Performing historical analysis may comprise building a model from data in the integrated channel partner database, and performing predictive analytics may comprise inputting attributes of a channel partner into the model to generate output corresponding to a prediction for the channel partner. Performing historical analytics and/or predictive analytics, may comprise predicting a channel partner's potential financial benefit to another channel partner, making a financial decision with respect to a channel partner, and/or determining incentives for a channel partner.

Integrating the channel partner data comprises joining data from a distributor performance data store and a reseller data store. Integrating the channel partner data may include providing a derived field in the channel partner database records. The derived field in a channel partner database record may be dynamically updated based upon a change to another field in a channel partner database record.

Channel partner data is integrated from a plurality of data sources into channel partner database records of an integrated channel partner database, to provide for historical/predictive analysis across multiple dimensions of a single record set. A database view is generated from the integrated channel partner database records, in which the database view corresponds to one or more channel partners. Historical analysis is performed on the database view to build a model corresponding to the one or more channel partners. Predictive analysis is performed using the model, including inputting attributes of another channel partner or potential channel partner into the model to receive output corresponding to the other channel partner or the potential channel partner. The output from the model is used to take action with respect to the other channel partner or the potential channel partner. An example action includes making a financial decision based upon the output from the model.

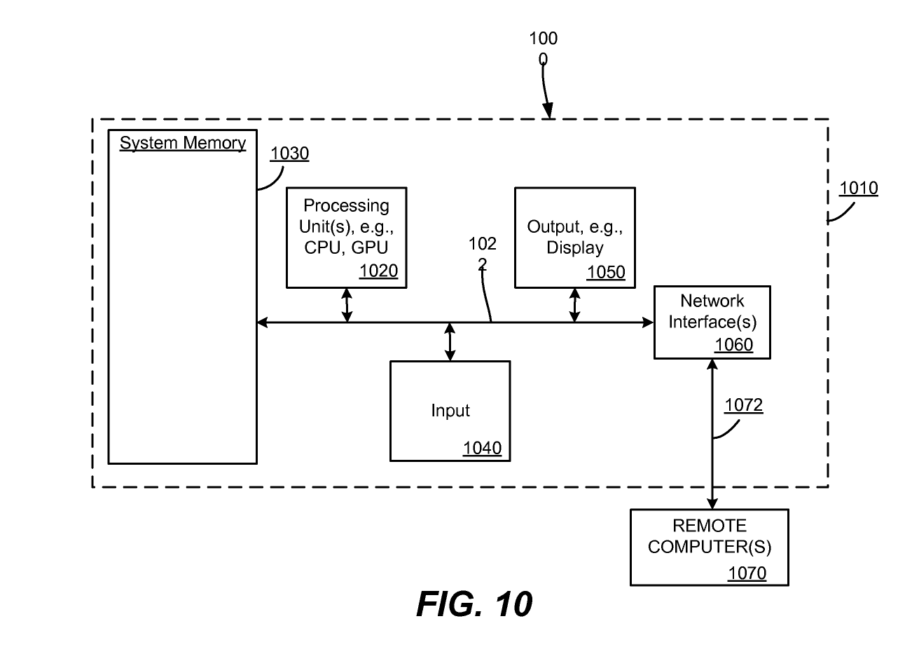

The techniques described herein can be applied to any device or set of devices capable of running programs and processes, including a distributed computer system or a desktop computing system/cloud computing system. It can be understood, therefore, that handheld, portable and other computing devices and computing objects of all kinds including cell phones, tablet/slate computers, gaming/entertainment consoles and the like are contemplated for use in connection with the various example implementations. Accordingly, the below computer described below in FIG. 10 is but one example of a computing device that may be adapted to perform the structure and functionality described herein.

The number and arrangement of components shown in FIG. 10 is provided as an example. In practice, there may be additional components, fewer components, different components, combined components and/or differently arranged components than those. Additionally, or alternatively, a set of components (e.g., one or more components) may perform one or more functions described as being performed by another set of components therein.

Example implementations can partly be implemented via an operating system, for use by a developer of services for a device or object, and/or included within application software that operates to perform one or more functional aspects of the various example implementations described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 10 thus illustrates an example of a suitable computing system environment 1000 in which one or more aspects of the example implementations described herein can be implemented, although as made clear above, the computing system environment 1000 is only one example of a suitable computing environment and is not intended to suggest any limitation as to scope of use or functionality. In addition, the computing system environment 1000 is not intended to be interpreted as having any dependency relating to any one or combination of components illustrated in the example computing system environment 1000.

With reference to FIG. 10, an example device for implementing one or more example implementations includes a general purpose computing device in the form of a computer 1010. Components of computer 1010 may include, but are not limited to, a processing unit 1020, a system memory 1030, and a system bus 1022 that couples various system components including the system memory to the processing unit 1020.

Computer 1010 typically includes a variety of machine/computer-readable media and can be any available media that can be accessed by computer 1010. The system memory 1030 may include computer storage media in the form of volatile and/or nonvolatile (i.e., non-transitory media) memory such as read only memory (ROM) and/or random access memory (RAM), and hard drive media, optical storage media, flash media, and so forth. By way of example, and not limitation, system memory 1030 may also include an operating system, application programs, other program modules, and program data.

A user can enter commands and information into the computer 1010 through input devices 1040. A monitor or other type of display device is also connected to the system bus 1022 via an interface, such as output interface 1050. In addition to a monitor, computers can also include other peripheral output devices such as speakers and a printer, which may be connected through output interface 1050.

The computer 1010 may operate in a networked or distributed environment using logical connections to one or more other remote computers, such as remote computer 1070. The remote computer 1070 may be a personal computer, a server, a router, a network PC, a peer device or other common network node, or any other remote media consumption or transmission device, and may include any or all of the elements described above relative to the computer 1010. The logical connections depicted in FIG. 10 include a network 1072, such as a local area network (LAN) or a wide area network (WAN), but may also include other networks/buses. Such networking environments are commonplace in homes, offices, enterprise-wide computer networks, intranets and the Internet.

As mentioned above, while example implementations have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, example implementations herein are contemplated from the standpoint of an API (or other software object), as well as from a software or hardware object that implements one or more example implementations as described herein. Thus, various example implementations described herein can have aspects that are wholly in hardware, partly in hardware and partly in software, as well as wholly in software.

The word “example” is used herein to mean serving as an example, instance, or illustration. For the avoidance of doubt, the subject matter disclosed herein is not limited by such examples. In addition, any aspect or design described herein as “example” is not necessarily to be construed as preferred or advantageous over other aspects or designs, nor is it meant to preclude equivalent example structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the example systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various example implementations are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

While the invention is susceptible to various modifications and alternative constructions, certain illustrated example implementations thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various example implementations described herein, it is to be understood that other similar example implementations can be used or modifications and additions can be made to the described example implementation(s) for performing the same or equivalent function of the corresponding example implementation(s) without deviating therefrom. Still further, multiple processing chips or multiple devices can share the performance of one or more functions described herein, and similarly, storage can be effected across a plurality of devices. Accordingly, the invention is not to be limited to any single example implementation, but rather is to be construed in breadth, spirit and scope in accordance with the appended claims.

What is claimed is:

1. In a computing environment, a system comprising, memory and one or more processors coupled to execute at least some of the memory, the memory containing:
an integrator component configured to integrate channel partner data from a plurality of data sources into channel partner database records to be stored in an integrated channel partner database;
historical analysis logic configured to build a model corresponding to one or more channel partners from a database view, in which the database view corresponds to the one or more channel partners and is generated from the integrated channel partner database records across multiple dimensions of a single record set; and
predictive analysis logic configured to use the model, including to input attributes of a channel partner or potential channel partner into the model to receive output corresponding to the channel partner or the potential channel partner, the predictive analysis logic further configured to use the output to determine a prediction score.

2. The system of claim 1 wherein the predictive analysis logic is coupled to other reseller data, the predictive analysis logic further configured to evaluate the prediction score with respect to at least one other prediction score of the other reseller data.

3. The system of claim 1 wherein the memory includes at least part of an automated action process.

4. The system of claim 1 wherein the automated action process is used in making a financial decision based upon the output from the model, or wherein the automated action process communicates with another technological system.

5. The system of claim 1 wherein the historical analysis logic comprises at least one predetermined analytic method configured to output statistical information with respect to a channel partner.

6. The system of claim 1 wherein the predictive analysis logic comprises at least one predetermined analytic method configured to output statistical information with respect to a channel partner.

7. The system of claim 1 wherein the integration component combines data from a data source related to reseller performance and a data source related to distributor performance.

8. The system of claim 1 wherein the data sources include at least one of: an incentive-related data source, a customer data source, a firmographics data source, a marketing data source, a coverage data source or a spend data source.

9. The system of claim 1 wherein the integration component is coupled to or incorporates a set of rules that ensure consistency between terminology in the channel partner database fields or terms, or both, among the data sources.

10. The system of claim 1 wherein the integration component is coupled to or incorporates a set of queries configured to dynamically update at least one field in at least one record when at least one other field in another record is changed in the channel partner database or in a data source.

11. A computer-implemented method comprising:
integrating channel partner data from a plurality of data sources into channel partner database records of an integrated channel partner database, including accessing each data source via an integrator implemented in memory to input data for the integrated channel partner database;
using rules on the input data, including detecting terminology corresponding to data in one data source and converting that terminology to other terminology to provide consistency of terminology among the channel partner database records; and
outputting a database view of at least some of the channel partner data.

12. The method of claim 11 further comprising, creating a channel partner identifier for at least some of the database records.

13. The method of claim 11 performing historical analytics and predictive analytics based upon the database view, wherein performing the historical analytics comprises building a model from data in the integrated channel partner database, and wherein performing the predictive analytics comprises inputting attributes of a channel partner into the model to generate output corresponding to a prediction for the channel partner.

14. The method of claim 11 wherein integrating the channel partner data comprises joining data from a distributor performance data store and a reseller data store.

15. The method of claim 11 wherein integrating the channel partner data includes providing a derived field in the channel partner database records.

16. The method of claim 15 further comprising, dynamically updating the derived field in a channel partner database record based upon a change to another field in a channel partner database record.

17. The method of claim 11 further comprising, performing historical analytics or predictive analytics based on the database view, or both, wherein performing the historical analytics, or the predictive analytics, or both comprises at least one of: predicting a channel partner's potential financial benefit to another channel partner, making a financial decision with respect to a channel partner, or determining incentives for a channel partner.

18. The method of claim 11 further comprising, outputting data representing the database view, including data that represents hierarchical relationships between channel partners.

19. One or more non-transitory machine-readable media having machine-executable instructions stored thereon comprising:
integrating channel partner data from a plurality of data sources into channel partner database records of an integrated channel partner database, to provide for historical analysis across multiple dimensions of a single record set;
generating a database view from the integrated channel partner database records, in which the database view corresponds to one or more channel partners;
performing historical analysis on the database view to build a model corresponding to the one or more channel partners;
performing predictive analysis using the model, including inputting attributes of another channel partner or potential channel partner into the model to receive output corresponding to the other channel partner or the potential channel partner; and
using the output from the model to take an action with respect to the other channel partner or the potential channel partner.

20. The one or more machine-readable media of claim 19 wherein using the output from the model to take an action comprises making a financial decision based upon the output from the model.
